(19) United States
(12) Patent Application Publication
(10) Pub. No.: US 2025/0252965 A1
(43) Pub. Date: Aug. 7, 2025

(54) GENERATION OF A PERSONALIZED SPEECH REPRESENTATION WITHIN AN AUDIO ENHANCEMENT MODEL

(71) Applicant: Microsoft Technology Licensing, LLC, Redmond, WA (US)

(72) Inventors: Tanel PARNAMAA, Tallinn (EE); Ando SAABAS, Tallinn (EE)

(73) Assignee: Microsoft Technology Licensing, LLC, Redmond, WA (US)

(21) Appl. No.: 18/431,496

(22) Filed: Feb. 2, 2024

(51) Int. Cl. G10L 21/0216

(52) U.S. Cl. CPC G10L 21/0216

(57) ABSTRACT

This document relates to enhancement of time-varying signals, such as audio signals. For instance, some implementations can compute a representation of the characteristics of a user's speech within a trained enhancement model. The representation can be employed to personalize the enhancement model, e.g., by suppressing sounds from sources other than the user's speech. In some cases, the representation can be computed based on a hidden state of a recurrent layer of the trained enhancement model.

### BACKGROUND

Machine learning can be used to perform a broad range of tasks, such as natural language processing, information retrieval, and image processing. One important application of machine learning involves processing of time-varying signals, such as audio or video signals. However, conventional machine learning techniques for processing time-varying signals have various drawbacks, as discussed more below.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to techniques for enhancement of time-varying signals. One example includes a method or technique that can be performed on a computing device. The method or technique can include obtaining a first microphone signal that includes speech by a user. The method can also include inputting the first microphone signal into a trained audio enhancement model, the trained audio enhancement model producing one or more first encodings from the first microphone signal. The method can also include generating a representation of speech characteristics of the user based at least on the one or more first encodings. The method can also include obtaining a second microphone signal that includes speech by the user. The method can also include inputting the second microphone signal into the trained audio enhancement model with the representation of the speech characteristics of the user. The method can also include obtaining an enhanced second microphone signal from the trained audio enhancement model. The method can also include outputting the enhanced second microphone signal, wherein inputting the representation of the speech characteristics of the user adapts the trained audio enhancement model to suppress sound sources in the second microphone signal other than the speech of the user.

Another example entails a system that includes a processor and a storage medium storing instructions. When executed by the processor, the storage medium storing instructions can cause the system to receive a representation of speech characteristics of a user, the representation being generated from encodings produced by a trained audio enhancement model from one or more audio signals that include speech by the user. The storage medium storing instructions can also cause the system to obtain a microphone signal that includes speech by the user. The storage medium storing instructions can also cause the system to input the microphone signal into the trained audio enhancement model with the representation of the speech characteristics of the user. The storage medium storing instructions can also cause the system to obtain an enhanced microphone signal from the trained audio enhancement model, wherein inputting the representation of the speech characteristics of the user adapts the trained audio enhancement model to suppress sound sources other than the speech of the user.

Another example includes a computer-readable storage medium storing instructions, which when executed by a computing device, cause the computing device to perform acts. The acts can include receiving a representation of speech characteristics of a user, the representation being generated from encodings produced by a trained audio enhancement model from one or more audio signals that include speech by the user. The acts can also include obtaining a microphone signal that includes speech by the user. The acts can also include inputting the microphone signal into the trained audio enhancement model with the representation of the speech characteristics of the user. The acts can also include obtaining an enhanced microphone signal from the trained audio enhancement model, wherein inputting the representation of the speech characteristics of the user adapts the trained audio enhancement model to suppress sound sources other than the speech of the user.

The above listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example workflow for using a model to enhance time-varying signals, consistent with some implementations of the present concepts.

FIG. 2 illustrates an example workflow for training a model to enhance time-varying signals, consistent with some implementations of the present concepts.

FIGS. 3A and 3B illustrate an example audio enhancement model, consistent with some implementations of the disclosed techniques.

FIG. 4 illustrates an example system, consistent with some implementations of the present concepts.

FIG. 5A illustrates an example teleconferencing scenario without personalized enhancement, consistent with some implementations of the present concepts.

FIG. 5B illustrates an example teleconferencing scenario with personalized enhancement, consistent with some implementations of the present concepts.

FIG. 6 illustrates an example method or technique for personalized enhancement of time-varying signals, consistent with some implementations of the disclosed techniques.

FIG. 7 illustrates an example user experience, consistent with some implementations of the present concepts.

FIG. 8 illustrates an example user interface, consistent with some implementations of the present concepts.

FIG. 9 illustrates experimental results obtained using some implementations of the present concepts.

### DETAILED DESCRIPTION

### Overview

Some signal processing applications involve using enhancement models to enhance a time-varying signal, such as by removing noise from an audio signal or sharpening a video signal. In some cases, enhancement models can be personalized for a particular user. For instance, in the audio context, a microphone signal picked up by a device associated with a particular user can be processed using a personalized audio enhancement model that can remove components of the microphone signal that are produced by sound sources other than that user's voice. In other words, the personalized audio enhancement model is adapted to isolate the user's voice by attenuating other components of the microphone signal. Thus, the enhanced microphone signal can have little or no detectable sound from sound sources other than the voice of the device's user.

However, techniques for personalized enhancement of signals can involve cumbersome enrollment processing steps. For instance, in audio enhancement scenarios, a separate speaker embedding model can be employed to generate speaker embeddings representing the vocal characteristics of each user. In some cases, a speaker embedding model can be trained in advance to predict whether two training example clips are produced by the same speaker, and the trained embedding model can be used to produce embeddings representing the vocal characteristics of new users by having the new users read a series of words during an enrollment session. Then, the speaker embeddings are input to a separate audio enhancement model that removes impairments such as echoes, noise, and/or reverberation to obtain an isolated speaker signal. Audio enhancement models can also improve signal quality through techniques such as bandwidth extension.

The disclosed implementations offer a unified approach that can determine the speaker embedding within the enhancement model, thus alleviating the use of a separate speaker embedding model. For instance, microphone and far end signals can be input to an enhancement model that has a recurrent component. The recurrent component can produce encodings (e.g., vector embeddings) that represent received audio frames. These embeddings can be averaged over time when a particular user is speaking to produce a speaker embedding for that particular user. In other cases, embeddings can be extracted from convolutional or transformer layers of an enhancement model.

By generating the speaker embedding inside of the same model that also performs enhancement processing, no separate embedding model is involved. In addition, the embedding for a given user can be computed on the fly, without necessarily involving a separate enrollment step. Furthermore, the embedding for that user can be continuously updated over time as the user continues to use the enhancement model, e.g., when participating in future teleconferences.

### Definitions

For the purposes of this document, the term “signal” refers to a function that varies over time or space. A signal can be represented digitally using data samples, such as audio samples, video samples, or one or more pixels of an image. A “time-varying signal” refers to a function that varies over time, such as an audio, video, sonar, or radar signal. A time-varying signal can be represented in a time domain, e.g., with samples representing the amplitude of the signal when sampled. A time-domain signal can also be represented in a frequency domain, e.g., with frequency information representing the extent to which the time-domain signal lies within different frequency bins. In some cases, time-domain representations can be converted to frequency-domain representations that include phase information, which can allow for recovery of the original time-domain representation.

The term “microphone signal” refers to an audio signal captured by a microphone. The term “far end signal” refers to the signal that is played back by a speaker in a room. A microphone can pick up the far end signal as distorted by the room impulse response. The term “near end signal” refers to an ideal microphone signal, the audio signal that an ideal microphone that does not introduce distortions would pick up in the absence of noise and echo. A “predicted near end signal” is an estimate of the near end signal. A predicted near end signal can be obtained by removing artifacts such as echoes or reverberations caused by playback of the far end signal, background noises such as fans, typing, or mouse clicks, noise introduced by hardware or software, etc. A “target signal” is a training signal (e.g., ideal) signal that a model can be trained to produce. In the case of audio processing, the target signal can be an example near end signal that represents the enhanced audio signal that a model is trained to produce given a microphone signal and a far end signal as input.

A “data enhancement model” refers to a model that processes an input signal to enhance the perceived quality of the signal. For instance, a data enhancement model could remove noise or echoes from audio data, or a data enhancement model could sharpen image or video data. The term “quality estimation model” refers to a model that evaluates an input signal to estimate how a human might rate the perceived quality of the signal. For example, a quality estimation model could estimate the quality of an unprocessed or raw audio signal, and can output a synthetic label characterizing the quality of the signal with respect to impairments such as device distortion, background noise, and/or room reverberation. A quality estimation model could also evaluate a processed audio signal that has been output by a particular data enhancement model to remove noise and/or echoes from a noisy input signal, and the quality estimation model could output a synthetic label reflecting how effective the particular data enhancement model was at removing noise and/or echoes as well as the extent to which the particular data enhancement model may have introduced undesirable artifacts when removing the noise. Here, the term “synthetic label” means a label at least partially generated by a machine, where a “manual” label is provided by a human being.

The term “model” is used generally herein to refer to a range of processing techniques, and includes models trained using machine learning as well as hand-coded (e.g., heuristic-based) models. For instance, a machine-learning model could be a neural network, a support vector machine, a decision tree, etc. Whether machine-trained or not, data enhancement models can include codecs or other compression mechanisms, audio noise suppressors, echo removers, distortion removers, image/video healers, low light enhancers, image/video sharpeners, image/video denoisers, etc., as discussed more below.

The term “impairment” is used herein to refer to any characteristic of a signal that reduces the perceived quality of that signal. Thus, for instance, an impairment can include noise or echoes that occur when recording an audio signal, or blur or low-light conditions for images or video. One type of impairment is an artifact, which can be introduced by a data enhancement model when removing impairments from a raw data sample. Viewed from one perspective, an artifact can be an impairment that is introduced by processing an input signal to remove other impairments. Another type of impairment is a recording device impairment introduced into a raw input signal by a recording device such as a microphone or camera. Another type of impairment is a capture condition impairment introduced by conditions under which a raw input signal is captured, e.g., room reverberation for audio, low light conditions for image/video, etc.

### Machine Learning Overview

There are various types of machine learning frameworks that can be trained to perform a given task, such as estimating the quality of a signal or enhancing a signal. Support vector machines, decision trees, and neural networks are just a few examples of machine learning frameworks that have been used in a wide variety of applications, such as image processing and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “internal parameters” is used herein to refer to learnable values such as edge weights and bias values that can be learned by training a machine learning model, such as a neural network. The term “hyperparameters” is used herein to refer to characteristics of model training, such as learning rate, batch size, number of training epochs, number of hidden layers, activation functions, etc.

A neural network structure can have different layers that perform different specific functions. For example, one or more layers of nodes can collectively perform a specific operation, such as pooling, encoding, decoding, alignment, prediction, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with internal parameters for the model structure that have been trained or tuned. Note that two trained models can share the same model structure and yet have different values for the internal parameters, e.g., if the two models are trained on different training data or if there are underlying stochastic processes in the training process.

### Signal Enhancement Overview

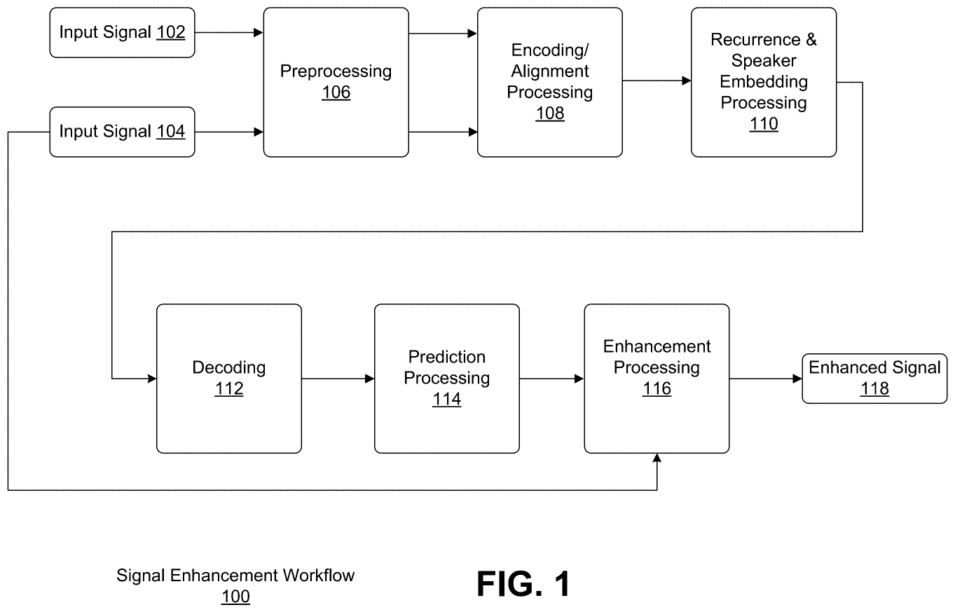

FIG. 1 shows an example of a signal enhancement workflow 100 with internal alignment processing. A first input signal 102 and a second input signal 104 are input to preprocessing 106. The preprocessing can output features representing the input signals to encoding/alignment processing 108, where the input signals can be encoded and aligned as discussed further below. For instance, the features can include power law spectra, mel spectrogram, or linear audio spectrogram features representing frequency components of the input signals. These features can be computed over frames of each of the input signals, where each frame includes a specified number of amplitude samples for each input signal.

The features for each frame can be projected into a linear space during encoding/alignment processing 108. For instance, convolutional operations can be employed to perform a projection on the features for each frame of the first input signal and each frame of the second input signal. For instance, projections can be obtained using convolution layers that produce features that can be input to the next layer. The projection or “encoding” of each frame of the second input signal can be compared to encodings of multiple frames of the first input signal. For instance, as discussed more below, encodings for one second worth of frames of the first input signal can be compared to an encoding of a single frame of the second input signal. The encodings of the frames of the first input signal can be weighted based on their respective similarity to the encoded single frame of the second input signal. The weights can be used to construct a weighted encoding of the first input signal frame that represents temporal alignment of the first input signal to the second input signal. Subsequent further encoding processing can be performed on the weighted first input signal frame and the second input signal frame using further convolution operations, as described more below. Each convolution operation can reduce the number of frequency bins of its received input.

After encoding and alignment, recurrence and speaker embedding processing 110 can process the current encodings of the first and second input signals based on hidden states that are maintained from previous encodings to produce outputs that are sent to decoding 112. Generally speaking, the use of recurrence processing allows a model to consider previous inputs when processing a current input. This can be useful in signal processing scenarios where certain artifacts tend to exhibit a memory effect, such as vibrations transmitted from a loudspeaker to a microphone. The recurrence processing can manipulate the projections of the received frames to provide input to decoding 112. These hidden states can be averaged over time to calculate an embedding. For instance, in an audio enhancement context, the embedding can represent the speech characteristics of a user, as described more below.

At decoding 112, the encodings are decoded, e.g., using one more convolution operations. The decoding convolution operations can produce an output having a greater number of frequency bins than the input received by that decoding convolution operation.

The output of the decoding processing 112 can be input to prediction processing 114. Generally speaking, the prediction processing can predict values that can be used to enhance the second input signal 104. For instance, for audio applications, the predicted values can include suppression masks, where each mask is a coefficient of a corresponding frequency bin.

The values predicted during prediction processing 114 can be used during enhancement processing 116 to obtain an enhanced signal 118. For instance, the suppression masks described above can be used to suppress individual frequency bins of the second input signal 104, resulting in an enhanced audio signal. In some implementations, the enhanced audio signal may have reduced echo, noise, and/or reverberation components that are removed by the enhancement processing.

### Training Overview

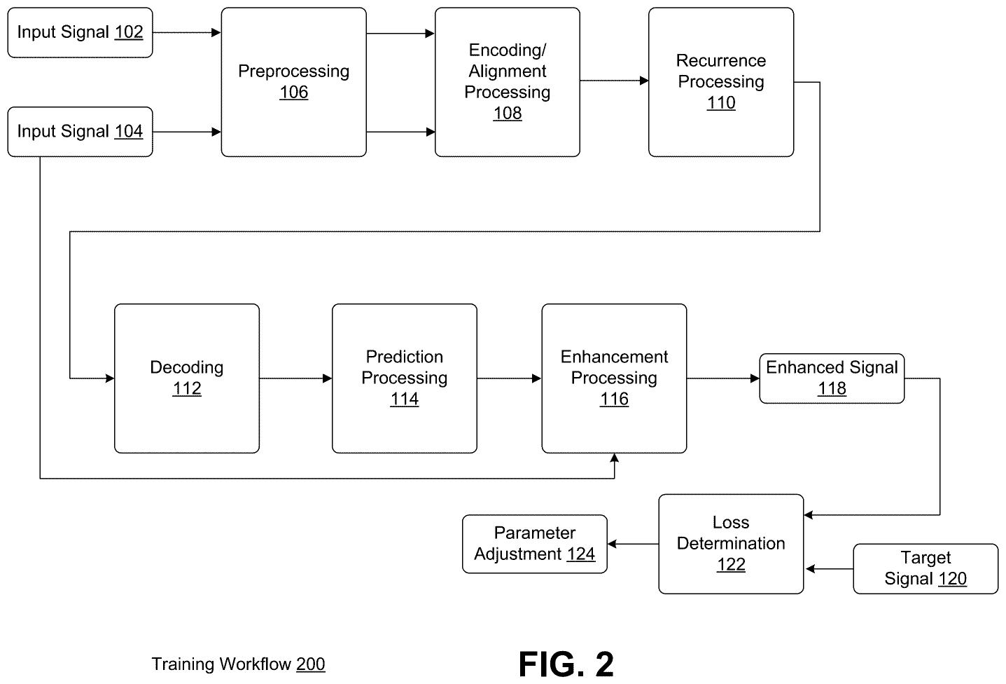

FIG. 2 shows an example of a training workflow 200. Training workflow 200 generally involves signal enhancement as described above with respect to FIG. 1, with additional functionality as described below.

As described above, first input signal 102 and second input signal 104 can be aligned prior to enhancing second input signal 104, resulting in enhanced signal 118. A target signal 120 can represent an ideal signal that the enhancement is trained to replicate. For instance, the target signal can be a clean microphone signal with little or no impairments, such as echoes or noise.

Loss determination 122 can be used to calculate a loss based on the difference between the enhanced signal 118 and the target signal 120. Based on the loss, parameter adjustment 124 can be performed to any or all internal parameters of encoding/alignment processing 108, recurrence and speaker embedding processing 110, decoding 112, and/or prediction processing 114. Generally speaking, the larger the difference between the target signal and the enhanced signal, the greater the loss will be. The parameter adjustments can be proportional to the loss gradient with respect to the individual parameters. Examples of a loss function and parameter adjustment techniques are described in more detail below.

### Specific Model Implementation

The above-described signal enhancement and training workflows can be employed for a wide range of applications involving different types of time-varying signals. The following provides a specific model architecture that can be employed for enhancement of audio signals.

Consider the following communication system for echo cancellation, noise suppression, and dereverberation processing: a far end reference signal is transmitted to a room, played back through a loudspeaker, and then picked up by a microphone via an acoustic echo path (modeled by a room impulse response). The captured microphone signal includes the voice of a speaker (e.g., a near end signal), background noise, reverberations, and echoes. The captured microphone signal is then processed by an audio enhancement model to produce a clean signal (a predicted near end signal) and the clean signal is sent to the far end user. The enhancement model's responsibility is to remove components of the microphone signal that are produced by sound sources other than the speaker's voice, e.g., by removing noise, echoes, and reverberations from the microphone signal using the far end signal as a reference.

Feature extraction. Generally, there is not a significant perceptual difference between fullband (48 kHz) and super wideband (24 kHz) signals. Thus, in some implementations, input and output audio are provided at 24 kHz to achieve a faster inference speed than 48 KHz. This can be implemented by downsampling 48 KHz input signals to 24 kHz, performing enhancement on the 24 kHz signals, and then upsampling the enhanced 24 kHz signals back to the original 48 KHz sampling rate. This preprocessing can be performed for both the reference far end and microphone signals. The input features to the enhancement model described below can include power law compressed complex spectra computed with a squared root Hann window.

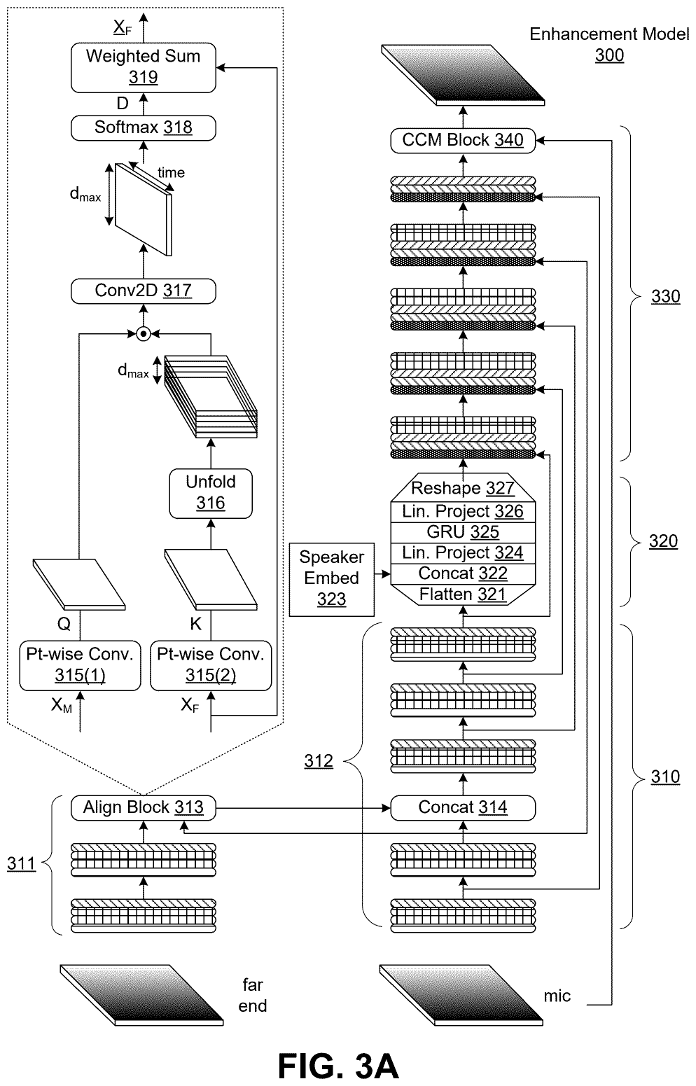

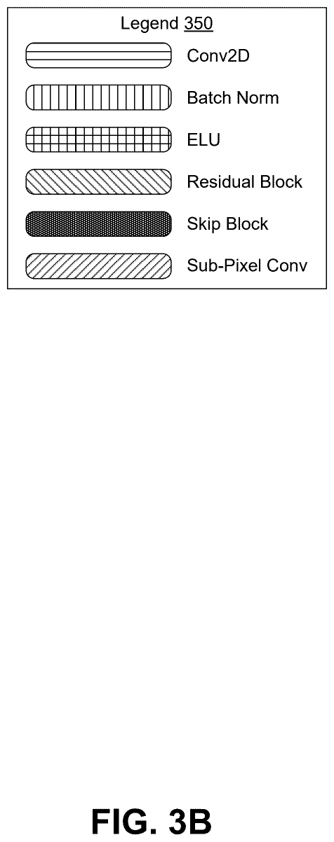

FIG. 3A shows an example enhancement model 300 having an encoder 310, a bottleneck 320, a decoder 330, and a complex convolving mask (CCM) block 340. The variables c, t, f ∈ [symbol] denote channel, time, and frequency axis lengths, respectively.

The encoder 310 includes a far end branch 311 and a microphone branch 312. The microphone branch has five encoding blocks, while the far end branch has two, followed by an alignment block 313. The alignment block aligns features representing current far end frame and features representing a current microphone in time. The aligned far end and microphone features are processed by concatenation 314 and fed into the third encoding block in the microphone branch. Each encoding block is built by stacking a downsampling convolutional layer, a batch-norm layer, an ELU function, and a residual block, as shown by legend 350 in FIG. 3B. The first microphone encoding block has 64 filters and the following microphone encoding blocks have 128 filters. The far end branch has 32 filters in the first block and 128 filters in the second block. The downsampling convolutional layers have kernel size 4×3 and a stride of 1×2, reducing the number of bins along the frequency axis. The convolutions are causal, meaning that the padding is performed so that no look-ahead is used.

Both encoding and decoding blocks of enhancement model 300 include residual blocks, which increase the network's capacity, while not hindering the gradient flow through the network. Each residual block has an associated convolutional layer, followed by a batch-norm operation and an exponential linear unit (ELU) activation operation. These operations can be formally defined as:

$$Y = X + ELU ( BatchNorm ( Conv 2 D ( X ) ) ) , \qquad ( 1 )$$

where X and Y ∈ [symbol] ^{c×t×f} are input and output tensors respectively. The convolution layer in the residual block has the same number of filters as the number of channels in the input, kernel size of 4×3, the stride of 1, and causal padding such as the input shape is preserved.

The following describes processing by alignment block 313. Let X_{M} ∈ [symbol] ^{c×t×f} be the mic features and X_{F} ∈ [symbol] ^{c×t×f} be the far end features. The feature maps are processed by point-wise convolution layers 315(1) and 315(2) into Q ∈ [symbol] ^{h×t×f} and K ∈ [symbol] ^{h×t×f}, respectively, where h is the number of similarity channels. Next, unfold operation 316 is performed on K on the time axis, creating a delay dimension and changing the shape to Kᵤ ∈ [symbol] ^{h×t×d}^{ₘₐₓ}^{×f}, where dₘₐₓ is the maximum echo delay expressed in time frames. Afterward, a dot product operation is performed on the frequency axis between the query and the unfolded key, obtaining Z ∈ [symbol] ^{h×t×d}^{ₘₐₓ}. The results are fed into a convolutional operation 317 with a kernel size of 5×3, padding of 3×1, and stride 1. The convolution operation has a single filter combining h similarity channels into a single attention head, which is further processed by a softmax operation 318 on the delay axis, outputting a delay probability distribution D ∈ [symbol] ^{t×d}^{ₘₐₓ}. Finally, the aligned far end features X_{F} ∈ [symbol] ^{c×t×f} are computed as a weighted sum 319 on the time axis with the corresponding delay probabilities from D. More precisely, for each delay value in [0, dₘₐₓ), X_{F} is delayed, multiplied by the corresponding weight factor from D, and added to the final result X_{F}.

Bottleneck. The bottleneck 320 is located between the encoder 310 and decoder 330. The bottleneck includes a flatten operation 321 on the feature maps from the encoder along the channel and frequency dimensions. Formally, the input X ∈ [symbol] ^{c×t×f} is flattened into X ∈ [symbol] ^{t×(c·f)}. Afterward, X is concatenated 322 with a speaker embedding 323, and fed into a linear projection 324 that projects the resulting concatenation to have the same dimension as X. The output of the linear projection is fed into gated recurrent unit (GRU) 325, fed into another linear projection 326, and then the linear projection output is reshaped 327 back to X ∈ [symbol] ^{c×t×f}. Using linear projection after the recurrent layer allows for a reduction of the number of hidden units in the recurrent layer improving both performance and training stability. As noted above, the speaker embedding can be obtained by averaging the hidden state of the gated recurrent unit over multiple audio frames (e.g., 10 seconds, an entire teleconference, etc.) while a given person is speaking.

Decoder. The decoder 330 includes five decoding blocks. Referring again to legend 350 in FIG. 3B, all but the last decoding block is built by stacking a skip block, a residual block, a sub-pixel convolution block, a batch-norm block, and an ELU function block. The last decoding block includes a skip block, residual block, and a sub-pixel convolution block. The number of filters in the decoder is changed in the sub-pixel convolution blocks, while the other blocks preserve the tensor shape. The number of filters for the sub-pixel blocks is 128, 128, 128, 64, and 27. Each sub-pixel convolution has the kernel size of 4×3 and a stride of 1. All convolutions are causal, meaning that the padding is added so that no look-ahead is performed.

Skip blocks. Classical skip connections, based on concatenation or summing, can be replaced with a convolutional layer, having a kernel size of 1×1 and a stride of 1. The encoder features are point-wise projected and then summed with the corresponding decoder output. Besides decoupling the encoder and decoder feature spaces, the point-wise convolution enables the number of channels in the encoder to be selected independently from the number of channels in the decoder and obtain better results for the performance-speed trade-off.

Sub-pixel convolution. After downscaling the input on the frequency axis in the encoder 310, the output of the bottleneck 320 is upscaled back to the original resolution in the decoder. Sub-pixel convolution can be employed (Shi, et al., “Real-time single image and video super-resolution using an efficient sub-pixel convolutional neural network,” In Proceedings of the IEEE conference on computer vision and pattern recognition, 2016, pp. 1874-1883), which learns an array of filters to upscale the low-resolution feature maps into the high-resolution output. Each upscaling is performed with a factor of two on the frequency axis. Formally, the X ∈ [symbol] ^{c}^{ᵢ}^{×t×f}, having cᵢ ∈ [symbol] channels, is transformed by a regular convolution with 2c filters into X′ ∈ [symbol] ^{2c×t×f}, and then transposed and reshaped into the actual output Y ∈ [symbol] ^{c×t×2f}.

Complex convolving mask block. The complex convolving mask (CCM) block 340 includes two stages. The first stage builds a complex-valued mask by splitting the input channels into three weight components. Each component is the weight of a 120 degree rotating vector in the complex plane. Define

$$v = ( {v}_{1} , {v}_{2} , {v}_{3} ) = ( 1 , - \frac{1}{2} + {j}^{\frac{\sqrt{3}}{2}} , - \frac{1}{2} - j \frac{\sqrt{3}}{2} )$$

and reshape the input X ∈ [symbol] ^{c×t×f} into X′ ∈ [symbol] ^{3×c/3×t×f}. Next, compute the complex mask H ∈

$${ℂ}^{\frac{c}{3} \times t \times f}$$

as described in Equation 2.

$$H = v \cdot {X}^{′} \qquad ( 2 )$$

Considering that the angle between v components is 120 degrees in the complex space, the complex mask covers the entire complex plane. In practice, using a three-vector component instead of the regular two-vector component (real and imaginary parts) offers more stable output results, preventing low noise and echo leakage.

In the second stage, the channel dimension of the complex mask H is reshaped to form a (m+1)×(2n+1) convolution kernel M ∈

$${ℂ}^{( m + 1 ) \times ( 2 n + 1 ) \times \frac{c}{3 ( m + 1 ) ( 2 n + 1 )} \times t \times f}$$

with weights varying over time and frequency dimensions. But, as the input microphone spectrum is a single channel complex valued tensor X_{mic} ∈ [symbol] ^{t×f}, then enforce c=3 (m+1)(2n+1). Therefore, having the input microphone spectrum X_{mic} ∈ [symbol] ^{t×f} and the complex convolving mask M ∈ [symbol] ^{(m+1)×(2n+1)×t×f} (after squeezing the redundant channel dimension), the clean spectrum X ∈ [symbol] ^{t×f} is estimated as described in Equation 3. The input spectrum X_{mic} is padded with zeros to ensure that clean spectrum X is produced for all frames and frequency bins.

$$X ( t , f ) = {\sum }_{i = - m}^{0} {\sum }_{j = - n}^{n} X ( t + i , f + j ) \cdot M ( i , j , t , f ) \qquad ( 3 )$$

Computing a deep filter for output reconstruction helps the network to leverage neighbor time-frequency bins in a learnable fashion. The CCM block is applied causally.

### Example System

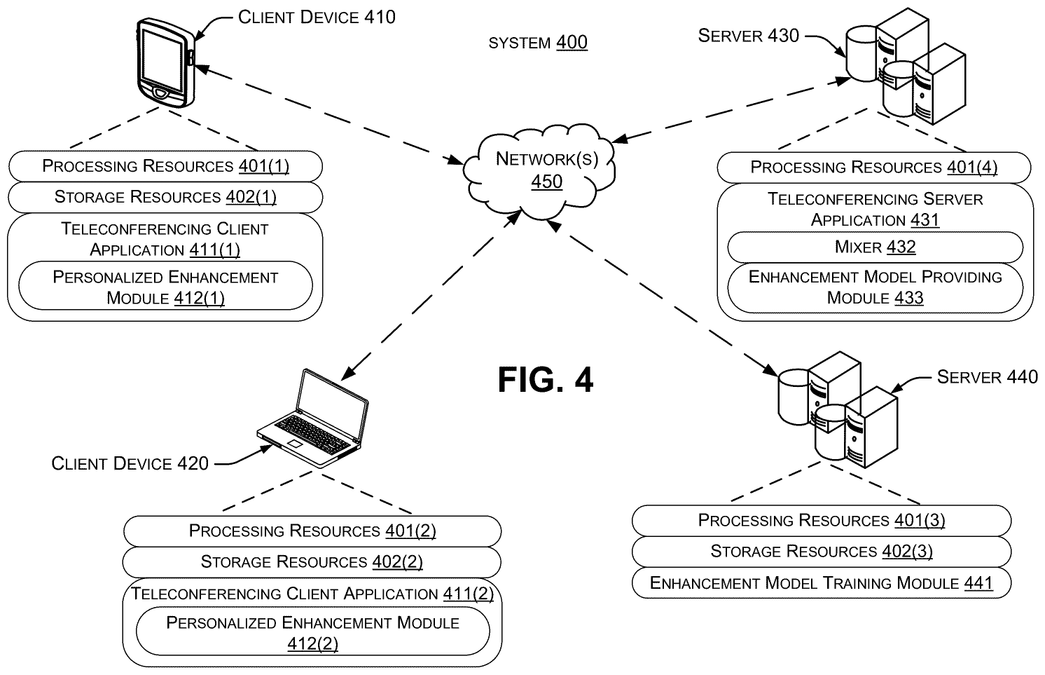

The present implementations can be performed in various scenarios on various devices. FIG. 4 shows an example system 400 in which the present implementations can be employed, as discussed more below.

As shown in FIG. 4, system 400 includes a client device 410, a client device 420, a server 430, and a server 440, connected by one or more network(s) 450. Note that the client devices can be embodied both as mobile devices such as smart phones or tablets, as well as stationary devices such as desktops, server devices, etc. Likewise, the servers can be implemented using various types of computing devices. In some cases, any of the devices shown in FIG. 4, but particularly the servers, can be implemented in data centers, server farms, etc.

Certain components of the devices shown in FIG. 4 may be referred to herein by parenthetical reference numbers. For the purposes of the following description, the parenthetical (1) indicates an occurrence of a given component on client device 410, (2) indicates an occurrence of a given component on client device 420, (3) indicates an occurrence of a given component on server 430, and (4) indicates an occurrence of a given component on server 440. Unless identifying a specific instance of a given component, this document will refer generally to the components without the parenthetical.

Generally, the devices 410, 420, 430, and/or 440 may have respective processing resources 401 and storage resources 402, which are discussed in more detail below. The devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client devices 410 and/or 420 can include respective instances of a teleconferencing client application 411. The teleconferencing client application can provide functionality for allowing users of the client devices to conduct audio teleconferencing with one another, with and/or without video functionality. Each instance of the teleconferencing client application can include a corresponding personalized enhancement module 412 configured to perform personalized microphone signal enhancement for a user of that client device. Thus, personalized enhancement module 412(1) can enhance microphone signals in a manner that is personalized to a first user of client device 410 when the first user is conducting a call using teleconferencing client application 411(1). Likewise, personalized enhancement module 412(2) can enhance microphone signals in a manner that is personalized to a second user of client device 420 when the second user is conducting a call using teleconferencing client application 411(2).

Teleconferencing server application 431 on server 430 can coordinate calls among the individual client devices by communicating with the respective instances of the teleconferencing client application 411 over network 450. For instance, teleconferencing server application 431 can have a mixer 432 that selectively mixes individual microphone signals from the respective client devices to obtain one or more playback signals and communicates the playback signals to the client devices during a call. For video conferencing scenarios, the mixer can also mix video signals together with the audio signals and communicate the mixed video/audio signals to participants in a call.

The teleconferencing server application can also have an enhancement model providing module 433 that provides an enhancement model (e.g., instances of enhancement model 300 shown in FIG. 3A) to each respective client device. As described more below, the enhancement model can be pre-trained using training data from various users to remove sound sources other than the user that speaks into that device. Each client device can modify the enhancement model provided by server 430 to obtain a respective personalized enhancement model.

The personalized enhancement module 412 on each client device can personalize a pretrained enhancement model received from server 430 by generating a representation of the speech characteristics of the user of that client device. For instance, as noted above, the internal state of a recurrent layer of an enhancement model can be averaged over multiple frames while the user of that client device is speaking. The average value can be employed as an embedding that represents the speech characteristics of that user. Thus, the pretrained enhancement model can be adapted for each user by determining an embedding representing that user and then subsequently using that embedding as an input to the model. In this manner, the same pretrained enhancement model can be adapted for a first user of client device 410 by using the pretrained model to determine a first embedding representing acoustic characteristics of speech by the first user, and adapted for a second user of client device 420 by using the pretrained model to determine a second embedding representing acoustic characteristics of speech by the second user. Once adapted for a given user, the respective personalized enhancement modules 412 can suppress other sounds picked up by microphones of the devices to help isolate the user's voice.

Server 440 can include a training module 441, which can train an enhancement model as described herein. For instance, training module 441 can implement training workflow 200, described above with respect to FIG. 2. The training can involve inputting microphone signals and far end signals to the enhancement model and training the enhancement model to reproduce target signals (e.g., ideal near-end signals) from the microphone and far end signals. The training signals can include speech by multiple different users under various capture conditions, e.g., different microphones, different rooms, with speakers at various distances from the microphones, etc.

### Voice Call Examples

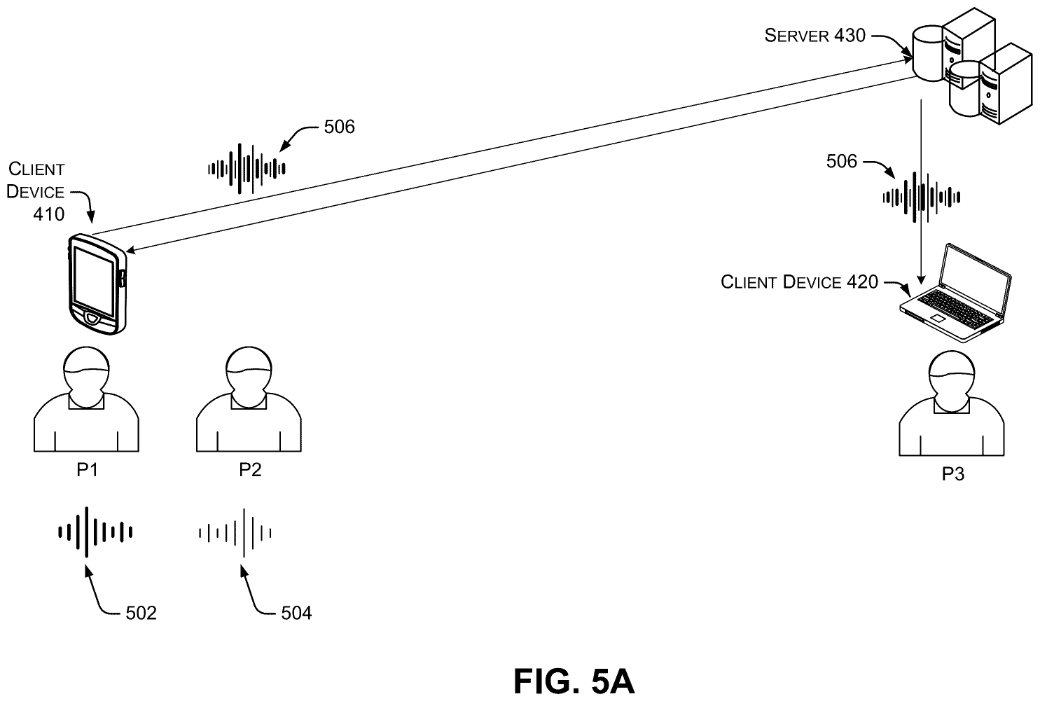

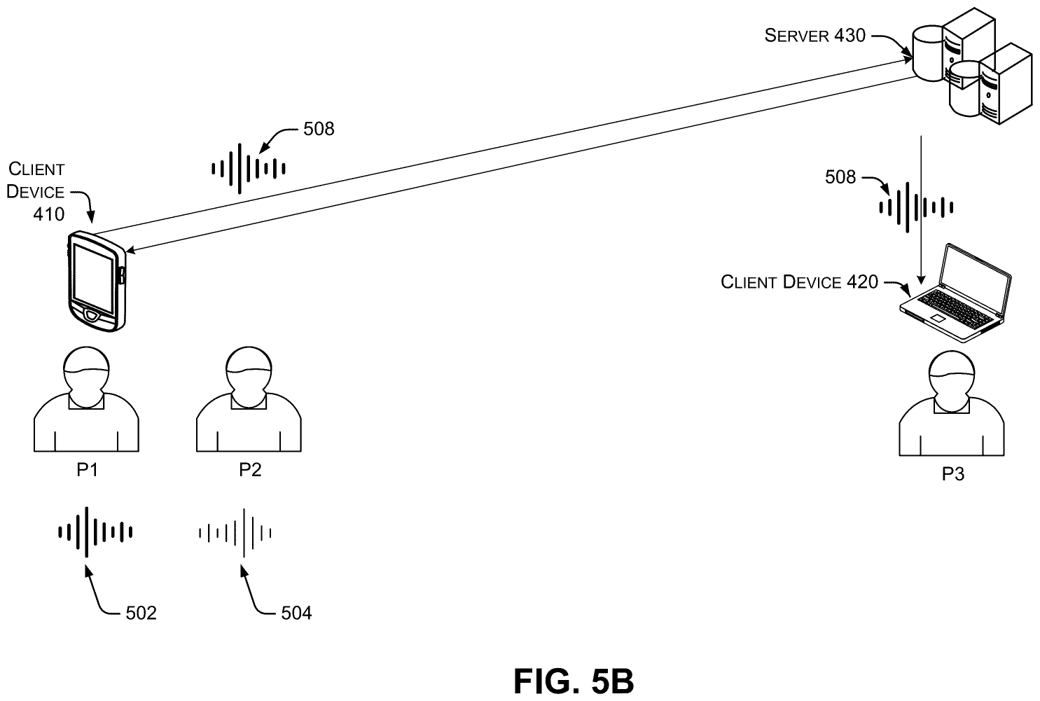

FIG. 5A illustrates a scenario where the respective client devices conduct an audio call without performing personalized enhancement. A first user P1 speaks a speech signal 502 into client device 410. A nearby speaker P2 also speaks a speech signal 504 which is picked up by a microphone of the client device 410. A microphone signal 506 is sent to server 430, which sends the microphone signal to client device 420 for playback over a loudspeaker. The speech signal 504 can degrade the audio quality of microphone signal 506.

FIG. 5B illustrates a scenario where the respective client devices conduct an audio call but the client device 410 employs personalized enhancement. Again, first user P1 speaks a speech signal 502 into client device 410 and a nearby speaker P2 speaks a speech signal 504. However, in this example, personalized enhancement of the microphone signal by the client device 410 removes components of the microphone signal that are attributable to sources other than the voice of user P1, including components attributable to speech signal 504. Thus, the microphone signal 508 is much more similar to the original speech signal 502, resulting in higher-quality audio when played back by client device 420.

### Example Enhancement Method

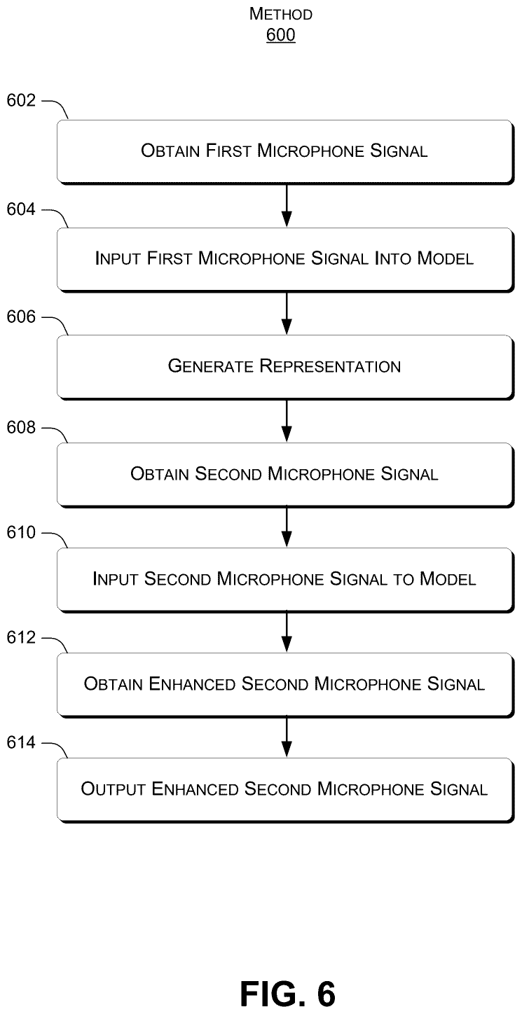

FIG. 6 illustrates an example method 600, consistent with some implementations of the present concepts. Method 600 can be implemented on many different types of devices, e.g., by one or more cloud servers, by a client device such as a laptop, tablet, or smartphone, or by combinations of one or more servers, client devices, etc.

Method 600 begins at block 602, where a first microphone signal is obtained. For instance, the first microphone signal can include speech by a user into a first client device. In some implementations, block 602 also involves obtaining a first far end signal, e.g., a signal received from a second client device for playback by the first client device.

Method 600 continues at block 604, where the first microphone signal is input to a trained audio enhancement model. In some implementations, the first far end signal is also input to the trained audio enhancement model. The trained audio enhancement model can produce one or more encodings representing the first microphone and/or first far end signals.

Method 600 continues at block 606, where a representation of the speech characteristics of the user is generated from the encodings. For instance, the representation can be an embedding that is computed by averaging the encodings over multiple audio frames while the user is speaking.

Method 600 continues at block 608, where a second microphone signal is obtained. For instance, the second microphone signal can be obtained after the first microphone signal, e.g., during the same call or during another call. In some implementations, block 608 also involves obtaining a second far end signal, e.g., a signal received from the second client device for playback by the first client device.

Method 600 continues at block 610, where the second microphone signal is input to the trained audio enhancement model. In some implementations, the second far end signal is also input to the trained audio enhancement model.

Method 600 continues at block 612, where an enhanced audio signal is obtained from the trained audio enhancement model. For instance, the enhanced audio signal can be personalized to the user voice by attenuating other components of the second microphone signal.

Method 600 continues at block 614, where the enhanced second microphone signal is output. For instance, the enhanced second microphone signal can be transmitted to the second client device (e.g., via a server) or another client device participating in the call, stored for later playback, etc.

### First Example User Experience

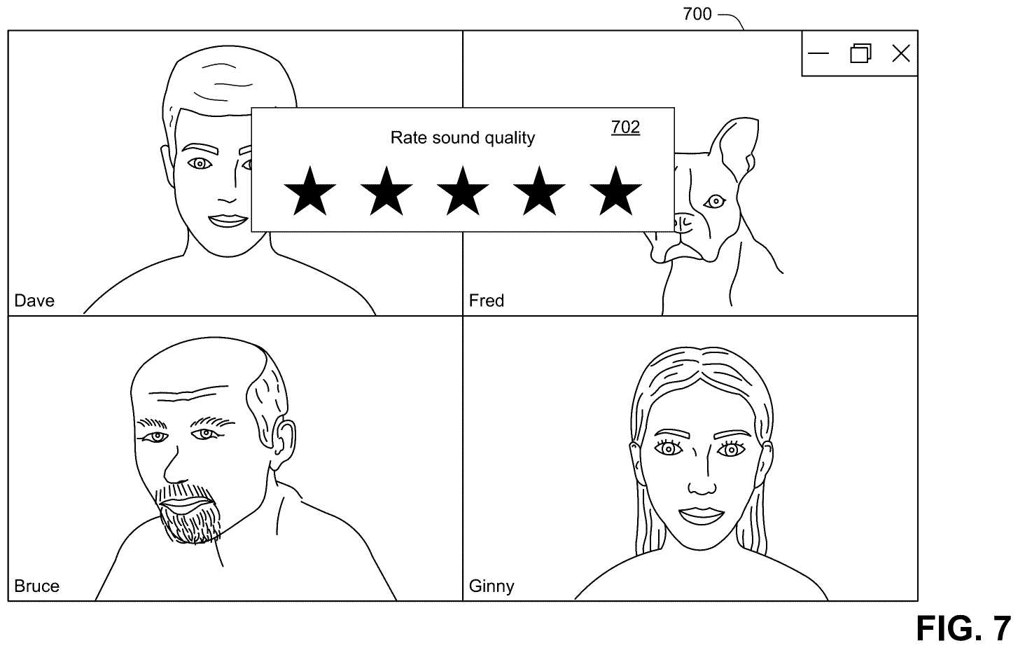

The disclosed techniques can result in improved sound quality during teleconferences. FIG. 7 illustrates a video call GUI 700 includes a sound quality estimate 702 that conveys a value of five stars out of five for the audio signal of a video call. In some cases, user estimates of signal quality can be used to manually label audio or video content of the call for subsequent training and/or tuning of various enhancement models that employ the signal alignment techniques described herein. For instance, user estimates of five-star signal quality for microphone signals enhanced during the call could be employed as examples of target near end signals. The corresponding raw microphone and far end signals recorded during the call can be provided with the enhanced microphone signals as training examples. In other cases, however, training examples can be generated synthetically or by using trained quality estimation models to rate the quality of training signals based on the presence or absence of impairments in the training signals.

### Second Example User Experience

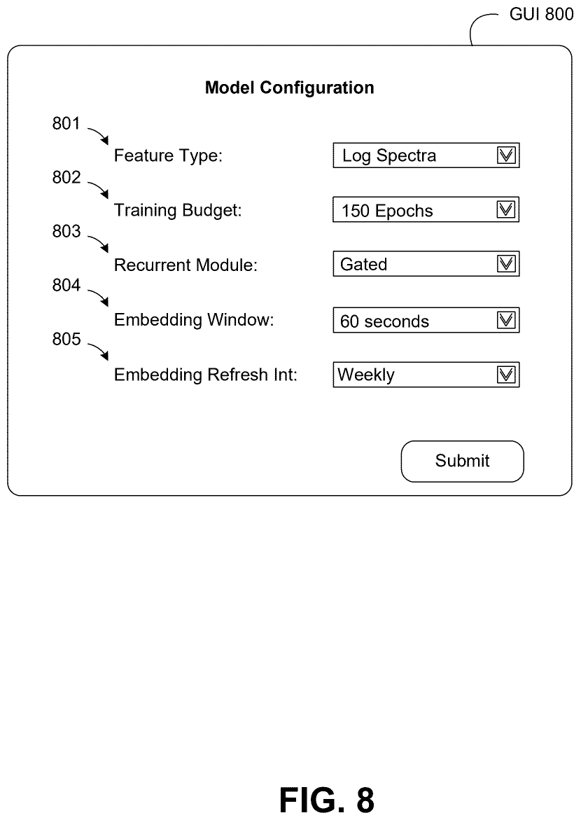

FIG. 8 illustrates an example configuration graphical user interface (“GUI”) 800 that can be presented by enhancement model providing module 433 on server 430 or enhancement model training module on server 440 to configure certain aspects of the enhancement model. For instance, feature type element 801 allows the user to pick the type of features used for training. Here, the user has selected log spectra, and the GUI may provide other feature type options such as mel or linear audio spectrogram features. Training budget element 802 allows the user to pick a training budget. Here, the user has selected 150 training epochs. The GUI may provide other options, such as an option to use all available training data, to specify a convergence condition, etc. In some cases, a text editor is employed to edit the text of training code and/or configuration files.

Recurrent module element 803 allows the user to select a type of recurrent module to use. Here, the user has selected a gated module such as a gated recurrent unit. The GUI may provide other options, such as an option to select an LSTM recurrent module. Embedding window element 804 allows the user to choose the length of time that is employed for determining respective user embeddings. Here, the user has selected 60 seconds, in other words, the embedding for each user can be calculated by averaging the internal state of the GRU for 60 seconds while the user is speaking. Embedding refresh interval element 805 allows the user to choose how often the embedding is refreshed. Here, the user has selected a weekly refresh. In other words, once per week, another 60 seconds of audio signals can be employed to update the embedding for each user.

When the user clicks submit, the enhancement model and associated training and/or embedding processing can be configured according to the user selections entered to configuration GUI 800. Note that the examples of elements shown in FIG. 8 are for example purposes, and that other types of elements can be used to specify other aspects of enhancement model processing. For instance, a configuration GUI can be provided with elements to configure the architecture of a neural network, e.g., by specifying the number and/or type of layers and how the layers are connected. For instance, the configuration GUI could be employed to add or remove convolutional layers, pooling layers, transpose convolution layers, recurrent layers, and/or skip connections to the model. The configuration GUI can also be used to select the number of kernels for each convolution layer, the type of pooling for pooling layers, etc. In addition, users can configure other training aspects such as max delay, frame size, hop size, etc.

### Technical Effect

The disclosed implementations offer several technical improvements over personalized signal enhancement techniques that use a separate embedding model to learn representations of a user's speech. By utilizing the internal state of an enhancement model to derive the embeddings, the same model can be employed to both generate a speaker embedding as well as personalized enhancement of audio using the speaker embedding. As a consequence, the processing, storage, memory, and/or network resources that would otherwise be employed for execution of the separate embedding model are saved.

As a related point, by using an enhancement model to derive speaker embeddings, no separate enrollment steps are necessarily employed. Rather, a user can simply participate in a call and, initially, the user's microphone signal can be enhanced in a non-personalized manner. Once enough frames of data have been received while the user is speaking, a personalized embedding can be calculated for that user and personalized enhancement can be initiated. Furthermore, the embedding can be periodically refreshed within the enhancement model, thus allowing the embedding to be continually updated without separate enrollment processing.

### Experimental Results

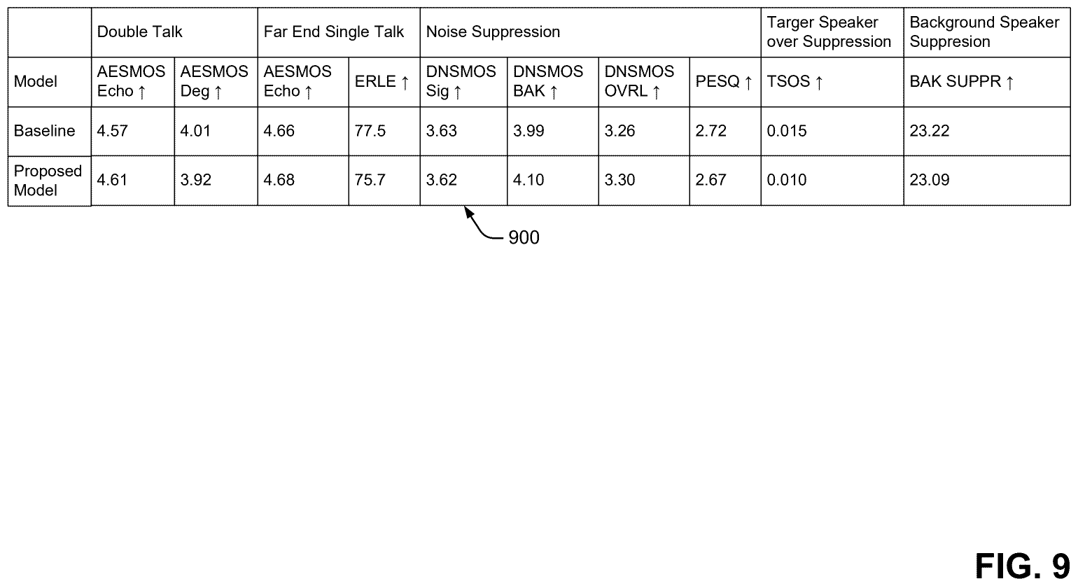

The techniques described herein were implemented and experiments conducted to evaluate the effectiveness of personalized audio enhancement using the disclosed techniques. The results of the experiments are shown in result table 900, in FIG. 9. Double talk and far end single talk metrics are based on the AECMOS evaluation model (Purin, et al., “AECMOS: A speech quality assessment metric for echo impairment,” In ICASSP 2022-2022 IEEE International Conference on Acoustics, Speech and Signal Processing, May 2022, pp. 901-905), and ICASSP 2023 AEC challenge blind test set (Cutler, et al., “ICASSP 2022 acoustic echo cancellation challenge,” In ICASSP 2022-2022 IEEE International Conference on Acoustics, Speech and Signal Processing, May 2022, pp. 9107-9111). Noise suppression metrics are based on the DNSMOS P. 835 evaluation model (Reddy, et al., “DNSMOS P. 835: A non-intrusive perceptual objective speech quality metric to evaluate noise suppressors,” In ICASSP 2022-2022 IEEE International Conference on Acoustics, Speech and Signal Processing, May 2022, pp. 886-890) and ICASSP 2023 DNS challenge blind test set (Dubey, et al., “ICASSP 2023 deep speech enhancement challenge,” arXiv preprint arXiv: 2303.11510, 2022).

Target speaker over-suppression (“TSOS”) metric (Eskimez, et al., “Personalized speech enhancement: New models and comprehensive evaluation,” In ICASSP 2022-2022 IEEE International Conference on Acoustics, Speech and Signal Processing, May 2022, pp. 356-360) is computed on a subset of AMI data from the AMI corpus, a data set of meeting recordings. Perceptual evaluation of speech quality (“PESQ”) and background speaker suppression (“BAK SUPPR”) metrics are computed on data synthesized from LibriVox data, a source of audio books. The BAK SUPPR metric is similar to echo return loss enhancement (“ERLE”), it measures the energy difference in dB between the model output and the input audio.

### Further Implementations

Note that the specific architecture of enhancement model 300 is but one implementation that can be employed for personalized enhancement of audio signals consistent with the concepts disclosed herein. For instance, models with different numbers or types of encoding and/or decoding blocks can be employed. In addition, some implementations may employ classical cross-correlation techniques to align the microphone and far end signals.

Furthermore, some implementations can employ different types of layers in the enhancement model. Instead of a recurrent layer, for instance, some implementations can split an audio signal into non-overlapping frames (e.g., 5 seconds) and process each frame independently without a recurrent layer. As another example, some implementations can use states of convolutional layers (e.g., in an encoder or decoder) and/or states of transformer encoder and/or decoder to derive a speaker embedding.

In addition, note that the concatenation 322 is but one way to fuse a speaker embedding with features representing microphone and far end signals. For instance, summation operations, multiplication operations, attention operations, and/or Feature-Wise Linear Modulation (FILM) (Perez, et al., “Film: Visual Reasoning with a General Conditioning Layer,” in Proceedings of the AAAI Conference on Artificial Intelligence, April 2018, Vol. 32, No. 1) operations could be employed to combine the information represented by the speaker embedding with information in the enhancement model representing the current audio frame. In addition, the concatenation or other operation could be performed in a different layer of the network, e.g., before or after the bottleneck 320.

In addition, some implementations can employ the techniques disclosed herein to derive representations of audio characteristics of microphones, room impulse responses, loudspeaker models, musical instruments, etc. These representations could be used to enhance audio signals for other purposes, e.g., to simulate how a given audio signal might sound if picked up by a specific model of microphone, played back in a specific room or over a specific model of loudspeaker, played through a particular model of guitar, etc.

In further implementations, image and/or video enhancement can be performed using embeddings generated within an image or video enhancement model. One approach could involve gathering face profiles from a separate enrollment video where the user has to make many facial expressions, and using internal state of the model when processing the enrollment video to derive a face embedding for an enrolling user. Another approach could involve deriving a face embedding from a segmentation model that runs in meetings to perform video enhancement such as background blur, e.g., by averaging the features of the face region over time.

In addition, a speaker embedding obtained from an audio enhancement model can be employed to help with personalized video enhancement. For example, in a scenario of personalized background blur, the speaker embedding representing speech characteristics of the user could be projected to that users' face embedding to implement zero-shot personalized segmentation. This could be employed in relatively simple scenarios, e.g., to differentiate between gender or age groups (children vs adults).

### Device Implementations

As noted above with respect to FIG. 4, system 400 includes several devices, including a client device 410, a client device 420, a server 430, and a server 440. As also noted, not all device implementations can be illustrated, and other device implementations should be apparent to the skilled artisan from the description above and below.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable medium” can include signals. In contrast, the term “computer-readable storage medium” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general-purpose hardware processor and storage resources. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), neural processing units (NPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.). Devices can also have various output mechanisms such as printers, monitors, etc.

Also note that the devices described herein can function in a stand-alone or cooperative manner to implement the described techniques. For example, the methods and functionality described herein can be performed on a single computing device and/or distributed across multiple computing devices that communicate over network(s) 450. Without limitation, network(s) 450 can include one or more local area networks (LANs), wide area networks (WANs), the Internet, and the like.

Various examples are described above. Additional examples are described below. One example includes a method comprising obtaining a first microphone signal that includes speech by a user, inputting the first microphone signal into a trained audio enhancement model, the trained audio enhancement model producing one or more first encodings from the first microphone signal, generating a representation of speech characteristics of the user based at least on the one or more first encodings, obtaining a second microphone signal that includes speech by the user, inputting the second microphone signal into the trained audio enhancement model with the representation of the speech characteristics of the user, obtaining an enhanced second microphone signal from the trained audio enhancement model, and outputting the enhanced second microphone signal, wherein inputting the representation of the speech characteristics of the user adapts the trained audio enhancement model to suppress sound sources in the second microphone signal other than the speech of the user.

Another example can include any of the above and/or below examples where the one or more first encodings are obtained from a hidden state in the trained audio enhancement model.

Another example can include any of the above and/or below examples where the hidden state being produced in a recurrent layer of the trained audio enhancement model.

Another example can include any of the above and/or below examples where the representation being an average of the hidden state of the recurrent layer over multiple audio frames.

Another example can include any of the above and/or below examples where the recurrent layer being a gated recurrent unit.

Another example can include any of the above and/or below examples where the method further comprises receiving a first far end signal associated with the first microphone signal, and inputting the first far end signal into the trained audio enhancement model with the first microphone signal, the one or more first encodings being produced by the trained audio enhancement model from the first microphone signal and the first far end signal.

Another example can include any of the above and/or below examples where the method further comprises receiving a second far end signal associated with the second microphone signal, and inputting the second far end signal into the trained audio enhancement model with the second microphone signal and the representation of the speech characteristics of the user, the trained audio enhancement model producing the enhanced second microphone signal from the second microphone signal, the second far end signal, and the representation of the speech characteristics of the user.

Another example can include any of the above and/or below examples where the trained audio enhancement model performing temporal alignment of the first microphone signal to the first far end signal and the second microphone signal to the second far end signal.

Another example can include any of the above and/or below examples where the enhanced second microphone signal is obtained by applying masks produced by the trained audio enhancement model to the second microphone signal.

Another example can include any of the above and/or below examples where the trained audio enhancement model attenuates at least one of noise, distortions, or echoes present in the second microphone signal or extends bandwidth of the second microphone signal.

Another example can include any of the above and/or below examples where the trained audio enhancement model produces a concatenation of the representation of the speech characteristics of the user with features representing current frames of the second microphone signal and the second far end signal.

Another example can include any of the above and/or below examples where the trained audio enhancement model produces a projection of the concatenation into a corresponding dimension of a flattened feature map, the projection being fed into the recurrent layer.

Another example can include a system comprising a processor, and a storage medium storing instructions which, when executed by the processor, cause the system to receive a representation of speech characteristics of a user, the representation being generated from encodings produced by a trained audio enhancement model from one or more audio signals that include speech by the user, obtain a microphone signal that includes speech by the user, input the microphone signal into the trained audio enhancement model with the representation of the speech characteristics of the user, and obtain an enhanced microphone signal from the trained audio enhancement model, wherein inputting the representation of the speech characteristics of the user adapts the trained audio enhancement model to suppress sound sources other than the speech of the user.

Another example can include any of the above and/or below examples where the instructions, when executed by the processor, cause the system to obtain a far end signal associated with the microphone signal, and input the far end signal into the trained audio enhancement model with the microphone signal, wherein the trained audio enhancement model aligns the microphone signal with the far end signal prior to processing resulting features with a recurrent layer.

Another example can include any of the above and/or below examples where the encodings are produced in the recurrent layer of the trained audio enhancement model.

Another example can include any of the above and/or below examples where the trained audio enhancement model produces a concatenation of the representation of the speech characteristics of the user with features representing current frames of the microphone signal and the far end signal prior to processing the concatenation via the recurrent layer.

Another example can include any of the above and/or below examples where the recurrent layer is a gated recurrent unit.

Another example can include any of the above and/or below examples where the instructions, when executed by the processor, cause the system to send the enhanced microphone signal to a device of another user that is participating in a call with the user or to a server that sends the enhanced microphone signal to the device of the another user.

Another example can include a computer-readable storage medium storing instructions which, when executed by a computing device, cause the computing device to perform acts comprising receiving a representation of speech characteristics of a user, the representation being generated from encodings produced by a trained audio enhancement model from one or more audio signals that include speech by the user, obtaining a microphone signal that includes speech by the user, inputting the microphone signal into the trained audio enhancement model with the representation of the speech characteristics of the user, and obtaining an enhanced microphone signal from the trained audio enhancement model, wherein inputting the representation of the speech characteristics of the user adapts the trained audio enhancement model to suppress sound sources other than the speech of the user.

Another example can include any of the above and/or below examples where the representation is an embedding and the acts further comprise refreshing the embedding based at least on the microphone signal, the embedding being generated and subsequently refreshed based at least on a state of a recurrent, convolutional, or transformer layer of the trained audio enhancement model.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A method comprising:
obtaining a first microphone signal that includes speech by a user;
inputting the first microphone signal into a trained audio enhancement model, the trained audio enhancement model producing one or more first encodings from the first microphone signal;
generating a representation of speech characteristics of the user based at least on the one or more first encodings;
obtaining a second microphone signal that includes speech by the user;
inputting the second microphone signal into the trained audio enhancement model with the representation of the speech characteristics of the user;
obtaining an enhanced second microphone signal from the trained audio enhancement model; and
outputting the enhanced second microphone signal,
wherein inputting the representation of the speech characteristics of the user adapts the trained audio enhancement model to suppress sound sources in the second microphone signal other than the speech of the user.

2. The method of claim 1, wherein the one or more first encodings are obtained from a hidden state in the trained audio enhancement model.

3. The method of claim 2, the hidden state being produced in a recurrent layer of the trained audio enhancement model.

4. The method of claim 3, the representation being an average of the hidden state of the recurrent layer over multiple audio frames.

5. The method of claim 3, the recurrent layer being a gated recurrent unit.

6. The method of claim 3, further comprising:
receiving a first far end signal associated with the first microphone signal; and
inputting the first far end signal into the trained audio enhancement model with the first microphone signal,
the one or more first encodings being produced by the trained audio enhancement model from the first microphone signal and the first far end signal.

7. The method of claim 6, further comprising:
receiving a second far end signal associated with the second microphone signal; and
inputting the second far end signal into the trained audio enhancement model with the second microphone signal and the representation of the speech characteristics of the user,
the trained audio enhancement model producing the enhanced second microphone signal from the second microphone signal, the second far end signal, and the representation of the speech characteristics of the user.

8. The method of claim 7, the trained audio enhancement model performing temporal alignment of the first microphone signal to the first far end signal and the second microphone signal to the second far end signal.

9. The method of claim 7, wherein the enhanced second microphone signal is obtained by applying masks produced by the trained audio enhancement model to the second microphone signal.

10. The method of claim 9, wherein the trained audio enhancement model attenuates at least one of noise, distortions, or echoes present in the second microphone signal or extends bandwidth of the second microphone signal.

11. The method of claim 10, wherein the trained audio enhancement model produces a concatenation of the representation of the speech characteristics of the user with features representing current frames of the second microphone signal and the second far end signal.

12. The method of claim 11, wherein the trained audio enhancement model produces a projection of the concatenation into a corresponding dimension of a flattened feature map, the projection being fed into the recurrent layer.

13. A system comprising:
a processor; and
a storage medium storing instructions which, when executed by the processor, cause the system to:
receive a representation of speech characteristics of a user, the representation being generated from encodings produced by a trained audio enhancement model from one or more audio signals that include speech by the user;
obtain a microphone signal that includes speech by the user;
input the microphone signal into the trained audio enhancement model with the representation of the speech characteristics of the user; and
obtain an enhanced microphone signal from the trained audio enhancement model,
wherein inputting the representation of the speech characteristics of the user adapts the trained audio enhancement model to suppress sound sources other than the speech of the user.

14. The system of claim 13, wherein the instructions, when executed by the processor, cause the system to:
obtain a far end signal associated with the microphone signal; and
input the far end signal into the trained audio enhancement model with the microphone signal,
wherein the trained audio enhancement model aligns the microphone signal with the far end signal prior to processing resulting features with a recurrent layer.

15. The system of claim 14, wherein the encodings are produced in the recurrent layer of the trained audio enhancement model.

16. The system of claim 15, wherein the trained audio enhancement model produces a concatenation of the representation of the speech characteristics of the user with features representing current frames of the microphone signal and the far end signal prior to processing the concatenation via the recurrent layer.

17. The system of claim 16, wherein the recurrent layer is a gated recurrent unit.

18. The system of claim 13, wherein the instructions, when executed by the processor, cause the system to:
send the enhanced microphone signal to a device of another user that is participating in a call with the user or to a server that sends the enhanced microphone signal to the device of the another user.

19. A computer-readable storage medium storing instructions which, when executed by a computing device, cause the computing device to perform acts comprising:
receiving a representation of speech characteristics of a user, the representation being generated from encodings produced by a trained audio enhancement model from one or more audio signals that include speech by the user;
obtaining a microphone signal that includes speech by the user;
inputting the microphone signal into the trained audio enhancement model with the representation of the speech characteristics of the user; and
obtaining an enhanced microphone signal from the trained audio enhancement model,
wherein inputting the representation of the speech characteristics of the user adapts the trained audio enhancement model to suppress sound sources other than the speech of the user.

20. The computer-readable storage medium of claim 19, wherein the representation is an embedding and the acts further comprise:
refreshing the embedding based at least on the microphone signal, the embedding being generated and subsequently refreshed based at least on a state of a recurrent, convolutional, or transformer layer of the trained audio enhancement model.
